(19) United States
(12) Patent Application Publication
(10) Pub. No.: US 2013/0205595 A1
(43) Pub. Date: Aug. 15, 2013

(54) Razor Cartridge

(71) Applicants: Henryk Bykowski, Solingen (DE); Gerhard Ermertz, Leichlingen (DE); Stephan Fischer, Gevelsberg (DE); Jochen Thoene, Wuppertal (DE)

(72) Inventors: Henryk Bykowski, Solingen (DE); Gerhard Ermertz, Leichlingen (DE); Stephan Fischer, Gevelsberg (DE); Jochen Thoene, Wuppertal (DE)

(73) Assignee: Eveready Battery Company Inc., St. Louis, MO (US)

(21) Appl. No.: 13/764,937

(22) Filed: Feb. 12, 2013

Related U.S. Application Data
(60) Provisional application No. 61/597,971, filed on Feb. 13, 2012.

(51) Int. Cl. B26B 21/14; B26B 21/40

(52) U.S. Cl. CPC B26B 21/14; B26B 21/4068
USPC 30/64; 29/428

(57) ABSTRACT

A method of making a razor cartridge is provided. A housing of the razor cartridge has an elongated body having, integrally formed, a guard, a cap and an interior wall extending between the guard and the cap close to an end of the elongated body. An exterior wall extends outwardly of the interior wall and is joined to the interior wall by a film hinge. A portion of a body of a razor blade is positioned in a slot of the interior wall. The exterior wall is folded about the film hinge so that a lip of the exterior wall overlays an end portion of the cutting edge of the razor blade to secure to razor blade within the housing. The exterior wall is additionally secured to the elongated body. A razor cartridge is thus provided.

### CROSS REFERENCE TO RELATED APPLICATIONS

This application claims the benefit of U.S. Provisional patent application Ser. No. 61/597,971, filed Feb. 13, 2012, the content of which is incorporated herein in its entirety for reference.

### TECHNICAL FIELD

The present subject matter relates to shaving systems of a wet shave type, and in particular relates to razor cartridges and housings therefor.

### BACKGROUND

Many modern safety razors include a disposable razor cartridge adapted to be selectively connected to a reusable handle by connecting structure therebetween. The cartridge includes a housing or frame having at least one razor blade with a sharpened cutting edge disposed therein. Other modern safety razors include a razor cartridge permanently connected to the handle that can be disposed of as a single unit.

The performance and commercial success of a razor cartridge is a balance of many factors and characteristics that include the accuracy and repeatability of positioning the razor blade(s) within the cartridge housing in order to provide optimal shaving geometry, such as exposure, angle and span.

In WO-A-2007/147420 a razor cartridge includes a plastic platform member and a plastic cover that are separate component parts. Blades are positioned in the platform and are located by features of the cover. The cover is assembled to the platform in a vertically downward direction (as seen in FIG. 2 therein) and joined thereto. In other types of well-known razor cartridges such as is disclosed in US-A1-2010/0308089, blades are positioned in a housing and retained therein by a pair of metallic bands or straps extending across the blades at respective opposing ends of the housing that engage the underside of the housing to retain the blade(s) in the housing.

In U.S. Pat. No. 4,184,247 a safety razor for a so-called double edge blade is disclosed. The razor includes a platform portion having guard portions. The platform portion is adapted to receive a razor blade, and a cap portion molded integrally with the platform portion. Means are provided to securely fasten the cap portion to the platform portion.

### SUMMARY

The present disclosure has for its objective to eliminate, or at least substantially alleviate the limitations of prior art razor cartridges. A method of making a razor cartridge is disclosed. A housing that includes an elongated body is provided. The elongated body has, integrally formed, a guard, a cap and an interior wall that extends between the guard and the cap at or close to an end of the elongated body. The interior wall includes a slot. An exterior wall extends from the interior wall in a direction along and outwardly of the elongated body and is joined to the interior wall by a film hinge. Preferably the interior wall includes a shelf and the exterior wall extends from the shelf. A razor blade is positioned in the housing by inserting a portion of a body of the razor blade in the slot. The exterior wall is folded about the film hinge so that a lip of the exterior wall overlays an end portion of a cutting edge of the razor blade to secure the razor blade within the housing. The exterior wall is then additionally secured to the elongated body (i.e. in addition to the film hinge) in a region spaced apart from the film hinge to provide a razor cartridge.

In some embodiments the exterior wall can include a protrusion that engages the body of the razor blade when the exterior wall is folded to locate the body within the slot and thus the razor blade within the housing. The exterior wall can be additionally secured to the elongated body portion by an application of a suitable adhesive or by welding methods. The exterior wall can also be additionally secured to the elongated body portion by a non-adhesive method such as by a snap-fit connection. The film hinge can comprise a thermoplastic elastomer material.

The housing can include a pair of interior walls at or close to opposed ends of the elongated housing body portion each having a respective outwardly extending exterior wall.

The body portion of the razor blade can include a first portion adjacent the cutting edge and a further portion bent at an angle relative to the first portion and a portion of the further portion is inserted in the slot of the interior wall.

The disclosed method offers manufacturing advantages by providing a one-piece housing that requires no additional component parts to secure the razor blade within the housing. The disclosed method offers advantages of improved positional accuracy of the razor blade and thus its cutting edge within the housing.

These and other advantages of the present disclosure will be apparent to one of ordinary skill in the art in light of the following Detailed Description and Drawings.

### BRIEF DESCRIPTION OF THE DRAWINGS

Reference is made to the attached drawings, wherein elements having the same reference numeral designations represent like elements throughout, and wherein:

FIG. 1 is a perspective view of an embodiment of a razor cartridge;

FIG. 2 is a sectional view of FIG. 1 along lines 2-2;

FIG. 2A is an enlarged view of a portion of FIG. 2;

FIG. 2B is an enlarged view of another embodiment of a housing for a razor cartridge taken at a position similar to FIG. 2A;

FIG. 3 is a sectional view of FIG. 1 along lines 3-3;

FIG. 3A is an enlarged view of a portion of another razor cartridge at a position similar to that indicated on FIG. 3;

FIG. 3B is a sectional view of another razor cartridge taken at a position similar to the section that is FIG. 3;

FIG. 4A is a sectional view of a razor blade of FIG. 3;

FIGS. 4B-4C are sectional views of other razor blades;

FIG. 5 is a perspective view of an embodiment of a housing for a razor cartridge; and

FIG. 5A is an enlarged view of a portion of FIG. 5;

### DETAILED DESCRIPTION

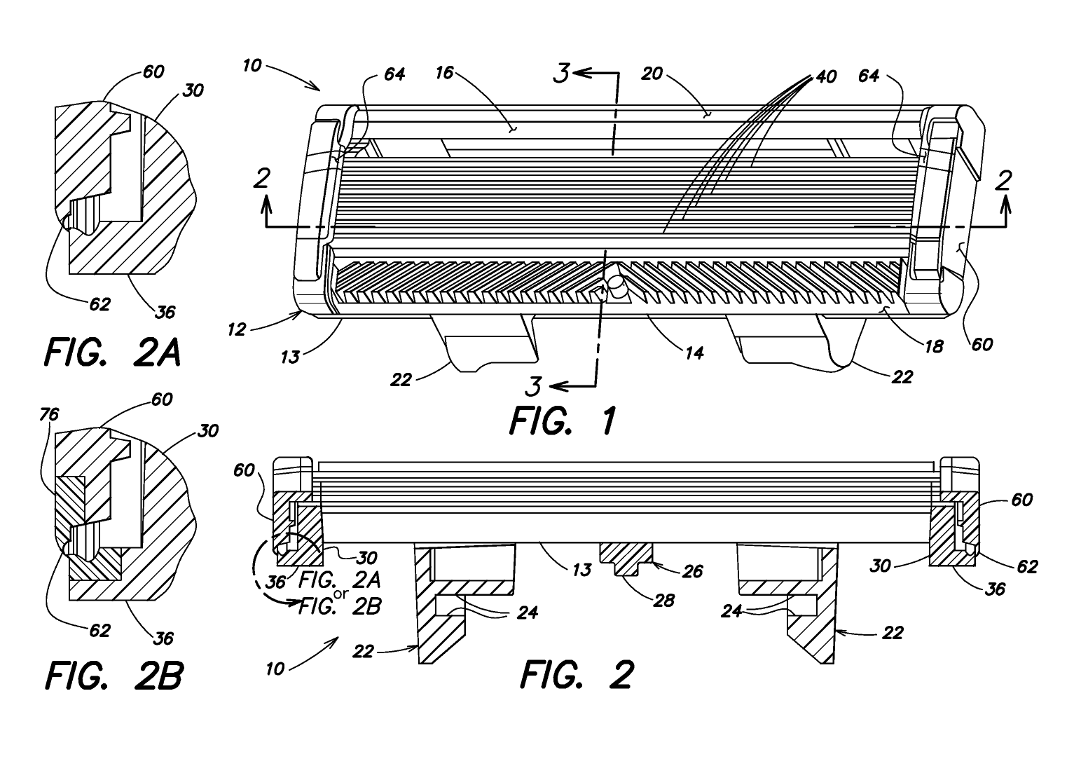

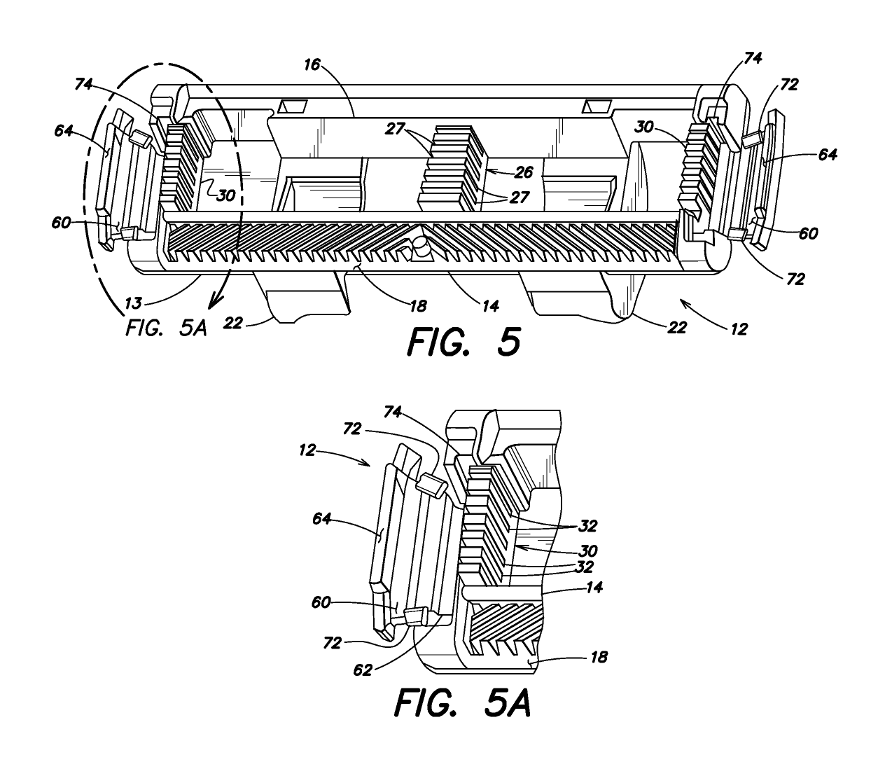

Referring now to the drawings and in particular FIGS. 1, 2, 2A and 3, a razor cartridge 10 is depicted. The cartridge comprises a housing 12 (additionally depicted in FIGS. 5 and 5A) having an elongated body 13. The elongated body 13 of the housing 12 has a guard 14 at the front and a cap 16 at the rear. The guard 14 and cap 16 can be provided respectively with a skin stretching/skin stimulating elastomeric member 18 and a shaving aid member 20 (n.b. FIGS. 5 and 5A omit shaving aid member 20 for clarity of depiction). The cap 16 can also comprise a wall defining a so-called geometry setting feature that can e.g. tangentially define an exposure of a cutting edge of the rearmost razor blade as described later in the present disclosure. Further structure, such as a lubrication box disclosed in commonly assigned patent application publication US-A1-2010/0023763 can be affixed to the wall. Such further structure affixed to the wall can also be an assembly including a further trimming blade. The housing has connecting structure 22 to connect, e.g. pivotally connect, the housing to a handle (not shown) to provide a safety razor. Such connection can be direct or via an interconnect member. For example the connecting structure can be provided with arcuate surfaces 24 that provide a shell bearing structure to engage mating structure of the handle. One or more webs 26, one of which can be centrally disposed, can join the guard and cap to provide structural stability to the housing and can include a cam surface 28 that can engage a biasing member of the handle to provide a biasing force to return the cartridge to an at-rest position if e.g. shaving forces pivot the cartridge away from its neutral position during normal use of the safety razor.

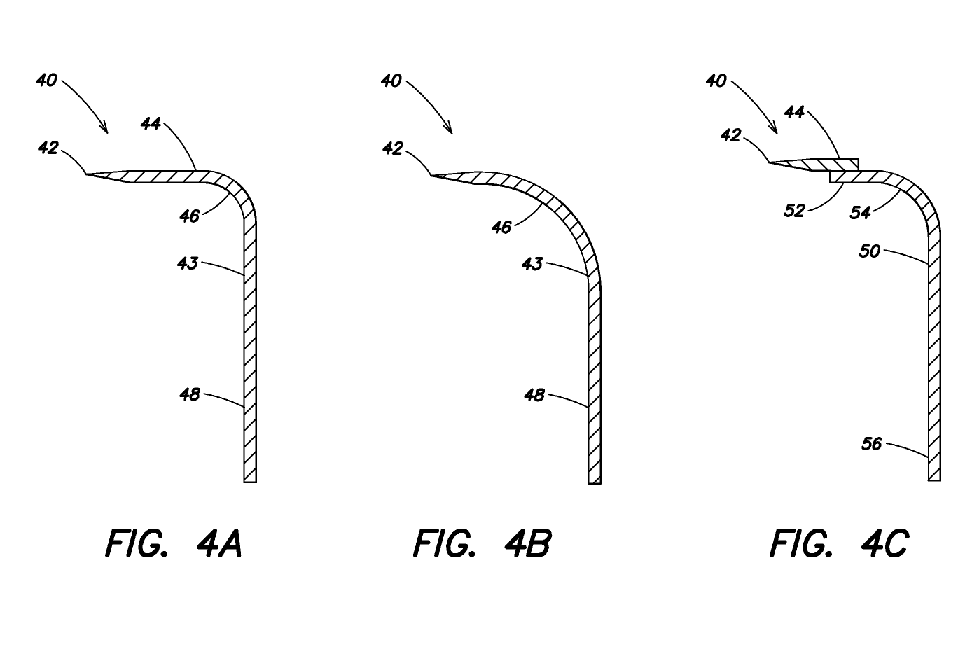

The cartridge also comprises one or more than one razor blades 40. As depicted six (6) razor blades are provided but any number can be provided, e.g. one, two, three, or more or less than six. Referring additionally to FIG. 4A preferably the razor blade is a so-called bent razor blade having a cutting edge 42 and a body 43. The body 43 has a first body portion 44 extending from and adjacent the cutting edge 42, a bent body portion 46 and a further body portion 48 at an angle to the first body portion adjacent the cutting edge. One or both of the first body portion 44 and further body portion 48 can be planar. Referring additionally to FIGS. 4B-4C in some embodiments one or more of the planar portions depicted in FIG. 4A can be omitted, e.g. in FIG. 4B the body portion 43 includes a bent body portion 46 having a larger radius than that shown in FIG. 4A that extends from the cutting edge 42. A further body portion 48 is at an angle to the portion of the razor blade body immediately adjacent the cutting edge. In FIG. 4C a razor blade is a razor blade having a cutting edge 42 and a first body portion 44 affixed, e.g. spot welded, to a bent support 50 having a support portion 52, a bent portion 54 and an upright portion 56 that provides a structural equivalent of a further body portion 48.

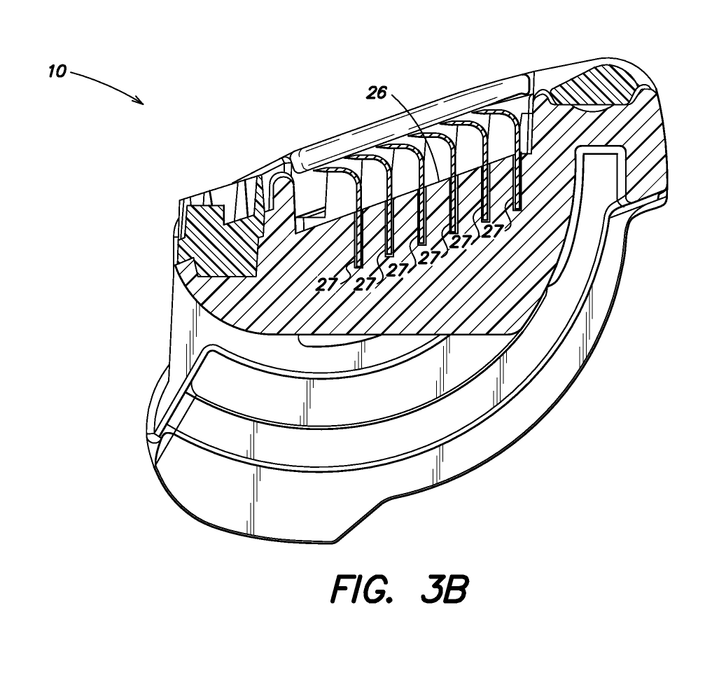

In the lateral end region of the elongated body 13 an interior wall 30 extends between the guard and cap in a position at or preferably close to an end of the elongated body. An interior wall 30 can be provided at each opposed end region of the housing body portion. The interior wall 30 includes one or more slots 32 to engage bodies of respective razor blade(s), e.g. part or substantially all of the further body portion 48 of the razor blade of FIG. 4A or the upright portion 56 of support 50 of the razor blade of FIG. 4C. As depicted in FIG. 3B, the web(s) 26 can also be provided with slots 27 that align with respective slots of the interior wall to provide structural support for the respective razor blades in positions between the interior walls.

In some embodiments the interior wall 30 is also provided with a support surface 34 provided to engage the underside of e.g. the first planar body portion 44 of the razor blade 40.

An exterior wall 60 extends from the interior wall 30 in a direction along and outwardly from the elongated body 13 as depicted in FIGS. 5 and 5A. Preferably the interior wall has a shelf 36 extending in a direction along and outwardly of the elongated housing and the exterior wall extends from the shelf. The exterior wall 60 is joined to the interior wall 30, preferably the shelf 36 of the interior wall 30, by a film hinge 62. The housing 12 of FIGS. 5 and 5A is the housing for the razor cartridge of e.g. FIG. 1, i.e. before the razor blade or blades are assembled thereto and other assembly steps performed. In other words, the housing 12 of FIGS. 5 and 5A is the housing as provided to the razor cartridge assembly process.

The exterior wall 60 also includes lip 64. The exterior wall can also include protrusion 66 that is provided with a location surface 68 to engage the upperside of e.g. the first planar body portion 44 of the razor blade 40. The protrusion 66 can further be provided with a second location surface 70 to locate the cutting edge 42 of the next adjacent razor blade 40 (see FIG. 3A).

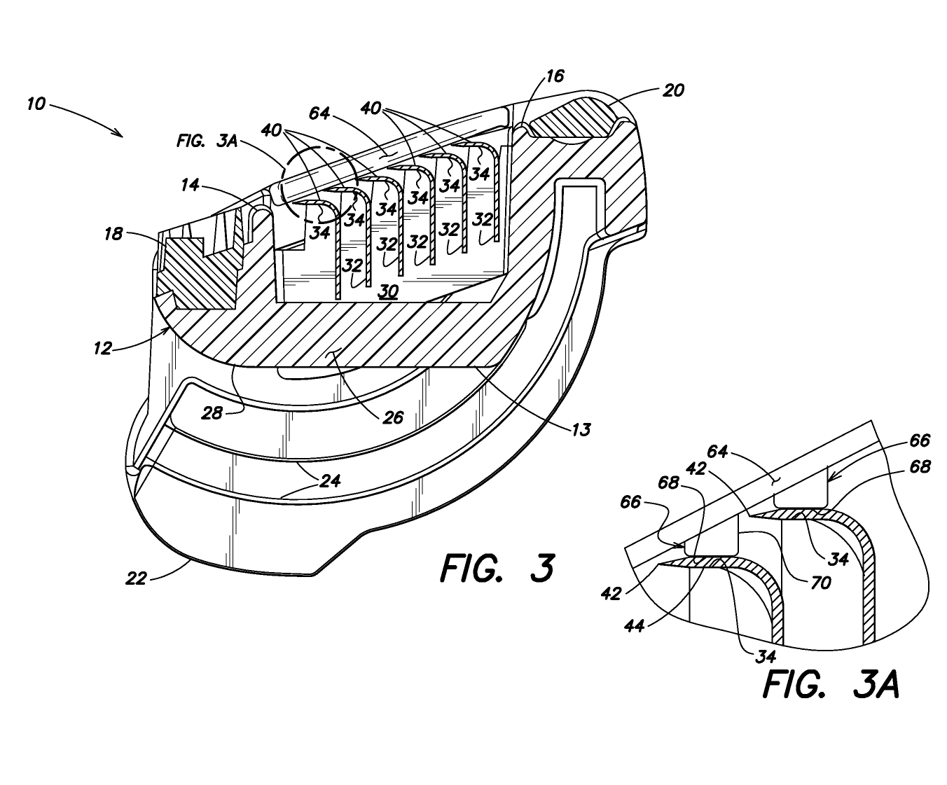

During the assembly process of the razor cartridge, the housing 12 is provided in the form depicted in FIG. 5. One or more razor blades 40 are positioned in the elongated body 13 by inserting e.g. the further body portion 48 of the razor blade in a respective slot 32. The further portion can be additionally secured in its respective slot by the addition of a suitable adhesive, such as a cyanoacrylate (CA). A suitable CA is discussed later in the present disclosure. After all of the razor blades are thus positioned, the exterior wall 60 is folded about film hinge 62 to the position shown in FIG. 2 wherein the lip 64 overlays an end portion of the cutting edge(s) 42 of the razor blades to accurately locate and secure each razor blade 40 to the housing 12. The exterior wall 60 is secured e.g. permanently secured in this position to the elongated housing body portion 13 by any suitable method such as by a snap fit connection whereby protrusion 72 of the exterior wall 60 engages recess 74 of the housing body portion. The snap-fit connection is remote, i.e. spaced away from the film hinge 62. In addition or in the alternative a suitable adhesive, such as a cyanoacrylate (CA), e.g. that designated LOCTITE 420 or LOCTITE 401 manufactured by HENKEL can be applied between the exterior wall 60 and the housing body portion 13, again in region(s) remote from the film hinge. The exterior wall 60 and the elongated body 13 can also be joined by ultrasonic welding or (plastics) laser welding.

Preferably the housing is manufactured by an injection molding process. A so-called multi-shot, e.g. a two- or three-shot molding process is more preferable as a skin stretching/skin stimulating elastomeric member 18 and/or a shaving aid member 20 can be integrally formed thereby as is known in the art. The housing is preferably injection molded ABS, more preferably the material designated GP-35, manufactured by BASF. This specific ABS is selected for properties that include: good compatibility with CA adhesive (where used); good dimensional stability at molding, good chemical resistance to substances typically found in a normal shaving environment and good impact strength. One of skill in the art will understand other thermoplastic molding materials such as polyphenylene oxide (PPO) or blends of ABS and other materials such as polyamide or polycarbonate can also be selected. Although component parts using film hinges are typically formed from olefinic materials such as polypropylene (PP) in the present disclosure the film hinge undergoes only a one-time movement from the as-provided position (e.g. in FIG. 5) to the assembled position (e.g. of FIG. 2). As this is a one-time movement, the applicants of the present disclosure have found that olefinic materials are not essential and other materials having e.g. better chemical resistance, dimensional stability and/or compatibility with adhesives can be utilized and are preferable.

In FIG. 2B the film hinge 62 and adjacent portions of adjoining structure comprises a thermoplastic elastomeric material 76. If the elongated body 13 of the housing 12 is provided with a skin stretching/skin stimulating elastomeric member 18 and the housing is manufactured by a multi-shot molding process then thermoplastic elastomeric material is available to be usefully incorporated in other regions of the housing. A thermoplastic elastomeric material hinge offers benefits of flexibility thereof while the remaining regions of the exterior wall 60 and the elongated body 13 comprise e.g. ABS for benefits as previously described.

While the foregoing has described what are considered to be the best mode and/or other examples, it is understood that various modifications can be made therein and that the subject matter disclosed herein can be implemented in various forms and examples, and that the teachings can be applied in numerous applications, only some of which have been described herein. For instance, features disclosed in connection with any one embodiment can be used alone or in combination with each feature of the respective other embodiments. It is intended by the following claims to claim any and all applications, modifications and variations that fall within the true scope of the present teachings.

What is claimed is:

1. A razor cartridge, comprising:
a housing having an elongated body having, integrally formed, a guard, a cap and an interior wall extending between the guard and the cap close to an end portion of the elongated body; and an exterior wall extending from the interior wall;
wherein the interior wall includes a slot;
wherein the exterior wall is joined to the interior wall by a film hinge; and
a razor blade having a cutting edge and a body;
wherein a portion of the body of the razor blade is positioned in the slot; and
wherein a lip of the exterior wall extends over an end portion of the cutting edge to secure the razor blade in the housing.

2. The razor cartridge of claim 1, wherein the exterior wall has a protrusion that engages the body of the razor blade to locate the razor blade within the housing of the razor cartridge.

3. The razor cartridge of claim 1, wherein the exterior wall is additionally joined to the elongated body in a region remote from the film hinge.

4. The razor cartridge of claim 1, wherein the body portion of the razor blade includes a first portion adjacent the cutting edge and a further portion bent at an angle relative to the first portion.

5. The razor cartridge of claim 4, wherein a portion of the further portion of the body of the razor blade is positioned in the slot.

6. The razor cartridge of claim 1, wherein the interior wall includes a shelf extending in a direction along the elongated body and outwardly of the interior wall and the film hinge extends from the shelf.

7. The razor cartridge of claim 1, wherein the film hinge comprises a thermoplastic elastomer.

8. The razor cartridge of claim 1, wherein the elongated body further includes a web extending between the guard and the cap.

9. The razor cartridge of claim 8, wherein the web includes a slot and the slot of the web is aligned with the slot of the interior wall to receive the portion of the body of the razor blade.

10. The razor cartridge of claim 1, wherein the housing has a pair of exterior walls each extending respectively from one of a pair of interior walls and wherein the exterior walls are disposed at opposed ends of the housing.

11. A method of making a razor cartridge, comprising the steps of providing a housing having and elongated body having, integrally formed, a guard, a cap and an interior wall extending between the guard and the cap close to an end portion of the elongated body; and an exterior wall extending from the interior wall;
wherein the interior wall includes a slot;
wherein the exterior wall includes a lip, and the exterior wall extends from the interior wall in a direction along and outwardly of the elongated body portion and is joined to the interior wall by a film hinge;
positioning a razor blade in the housing by inserting a portion of a body of the razor blade in the slot;
folding the exterior wall about the film hinge so that the lip overlays an end portion of the cutting edge of the razor blade to secure the razor blade within the housing; and
additionally securing the exterior wall to the elongated body portion in a region remote from the film hinge.

12. The method of claim 11, wherein the exterior wall has a first protrusion and when the exterior wall is folded about the film hinge the first protrusion engages the body of the razor blade to locate the body relative to the slot.

13. The method of claim 11, wherein the exterior wall is additionally secured to the elongated body portion by one of an application of an adhesive therebetween, a snap fit connection therebetween and a welded connection therebetween.

14. The method of claim 11, wherein the housing has a pair of exterior walls each extending respectively from one of a pair of interior walls and wherein the exterior walls are disposed at opposed ends of the housing.
